(19) United States
(12) Patent Application Publication
(10) Pub. No.: US 2018/0374031 A1
(43) Pub. Date: Dec. 27, 2018

(54) TRANSPORTATION ADJUSTMENTS BASED ON RECOMMENDED SHIPPING PACKAGES

(71) Applicant: Amazon Technologies, Inc., Reno, NV (US)

(72) Inventors: HAO HE, Seattle, WA (US); Lubos Bosak, Everett, WA (US); Weikeng Qin, Seattle, WA (US); Michael Cary Solomon, Seattle, WA (US); Casey Nicole Thurmond, Seattle, WA (US); Nathan Ryan Bosch, Burien, WA (US); Xiaomin Zhang, Seattle, WA (US); Udit Madan, Seattle, WA (US); David Daniel Glick, Seattle, WA (US); Michael Ellsworth Bundy, Seattle, WA (US)

(73) Assignee: Amazon Technologies, Inc., Reno, NV (US)

(21) Appl. No.: 14/204,799

(22) Filed: Mar. 11, 2014

(51) Int. Cl. G06Q 10/08

(52) U.S. Cl. CPC G06Q 10/083

(57) ABSTRACT

Transportation plan adjustments based on recommended shipping packages may utilize a shipment data model for a facility that is updated with cubic volumes of recommended packages for received orders. The shipment data model may also be updated with the cubic volumes of the packages that are actually used to pack the orders and transportation utilization data such as assignment of packages to particular transportation resources. A transportation plan may be updated based on the updated shipment data model and transportation utilization data such as which transportation resources have left the facility and how much of the available cubic volume of the resource was used when the resource left the facility. The transportation plan may be updated at times associated with transportation resource change deadlines from one or more transportation resource providers. Adjustments to previously scheduled transportation resources may be made based on the updated transportation plan.

### BACKGROUND

Manufacturers, distributors, retailers, and other entities with facilities (which may collectively be referred to as materials handling facilities) typically receive, process and send materials using transportation resources. For example, transportation resources such as trucks, trains, ships, airplanes and the like may be used to receive or ship raw materials, components for finished products or finished products. The raw materials, components or finished goods may be packaged into various packages for shipment. For example, a distributor may pack items that have been ordered by a customer into a package for shipment to the customer.

Some materials handling facilities may manage the transportation resources used to receive and send materials. For example, a large retailer may rely upon contracted carriers for shipping orders to customers and may have agreements with the contracted carriers to order amounts of transportation from the contracted carriers by specified times in order to receive preferred pricing for shipping materials. A facility may use historical estimates of demand and an average cubic volume of a package per order to predict how much of a transportation resource to order. However, historical demand and average package cubic volume is not always an accurate predictor of actual demand or actual package cubic volume. The number of orders received and the cubic volumes for received orders may be significantly different with respect to the cubic volume of transportation resources that were scheduled based on estimated demand and average cubic volume.

### BRIEF DESCRIPTION OF THE DRAWINGS

FIG. 1 is a block diagram that illustrates relationships between processes and objects of a materials handling facility to determine transportation plan adjustments, according to some embodiments.

FIG. 2 illustrates a logical representation of various operations of a distribution facility, according to some embodiments.

FIG. 3 illustrates a block diagram for a reactive transportation scheduling system with a shipment modeling component, according to one embodiment.

FIG. 4 illustrates a flow diagram of a transportation plan creation and transportation scheduling process, according to one embodiment.

FIG. 5 illustrates a flow diagram of an update process used at a materials handling facility, in some embodiments.

FIG. 6 illustrates a flow diagram of a shipment data model adjustment process using package recommendations, implemented by a reactive transportation scheduling system of a materials handling facility, according to one embodiment.

FIG. 7 illustrates a flow diagram of a shipment data model update process, implemented by a reactive transportation scheduling system of a materials handling facility, according to one embodiment.

FIG. 8 illustrates a flow diagram of a transportation utilization update process implemented by a reactive transportation scheduling system of a materials handling facility, according to one embodiment.

FIG. 9 illustrates a flow diagram of transportation plan adjustment determination process implemented by a reactive transportation scheduling system of a materials handling facility, according to one embodiment.

FIG. 10 is a block diagram illustrating a computer system suitable for use in various of the embodiments disclosed herein.

While embodiments are described herein by way of example for several embodiments and illustrative drawings, those skilled in the art will recognize that the embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION OF EMBODIMENTS

Various systems and methods for estimating and adjusting transportation resource utilization based on cubic volumes of recommended packages for shipping items are disclosed. In some embodiments, such a method may be used to more accurately order, schedule or adjust plans for transportation resources. The system may operate in environments in which the cubic volume, weight or other characteristic(s) of forecasted shipments change, with the system automatically adapting to such changes, in various embodiments. For example, sales volumes of materials may change seasonally or with the health of the economy such that historical demand (e.g., what happened last month) may not always be an accurate predictor of the current months likely demand or received orders. Additionally, weights and cubic volumes of items and packages and packing materials may change over time.

In some embodiments, a transportation plan may be created based on the historical package shipment data or forecasted demand for the items shipped in the packages. For example, an enterprise-level planning system may create a transportation plan for a facility. An existing transportation plan may be based upon the number and capacity of the transportation resources (e.g., trucks) that have been ordered or schedule to transport the shipments. Improving the accuracy of data used as inputs to a transportation plan may be desirable, for instance, for reducing fees associated with inaccurate transportation resource scheduling.

In some embodiments, a shipment data model may be used as a source of data to update an existing transportation plan. A shipment data model may include data about the shipments that will be shipped from a facility via transportation resources. For example, a shipment data model may include data about the packages such as the number and cubic volumes or weights of packages estimated to be shipped by truck assignment. In some embodiments, a system (e.g., a reactive transportation scheduling system) may take inputs and update the shipment data model based on the inputs. Inputs to the shipment data model may include any of various data, such as pre-packaging order data (e.g., indications of the recommended packages used to pack the orders), post-packaging order data (e.g. actual cubic volumes and weights of the packed packages, sometimes referred to as shipments), and transportation resource utilization data (assignment of orders, packed packages or shipments to particular transportation resources). A software component, such as a shipment modeling component may update the shipment data model as values of these and other inputs are received.

A transportation plan may be updated or adjusted for various reasons, for example, based on transportation change deadlines from transportation resource providers (e.g., trucking companies) or as determined by management of the facility for any number of reasons. A transportation plan (e.g., an existing transportation plan) may be updated based on the shipment data model. For example, as orders are received, estimated orders are replaced with received orders and values of estimated demand are replaced or updated with values for actual or received orders. In some embodiments, cubic volumes of the recommended containers for the received orders replace estimated cubic volumes of forecasted demand prior to packing. In some embodiments, cubic volumes of the actual packages used to pack the items of an order replace the cubic volumes of the recommended containers subsequent to packing or as packing is performed, progressively improving the accuracy of the cubic volume of the shipments to be shipped via the transportation resources, in some embodiments. The improved accuracy of the shipment data model may increase the accuracy of the transportation resource plan, sometimes referred to as a transportation plan, in embodiments.

A similar process may be used for updating a shipment data model based on package weight in addition to or instead of package cubic volume. For example, the average weight of shipments may be used to preliminarily schedule transportation resources. As orders are received, stored weights (e.g., from a product database) corresponding to items of received orders and known weights of recommended packages for shipping the orders may replace the average weight (or otherwise be used to update the shipment data model), for example in the weight-based shipment data model. In some embodiments, after orders have been packed into shipments and weighed, the measured weights of the shipments may be used to update the weight-based shipment data model (e.g., replace the values determined from the stored weights in the product database). In some embodiments, transportation plan adjustments may be determined and output based on the difference between the shipment data model and the transportation capacity (e.g., weight or cubic volume capacity) according to the existing transportation plan. Although multiple embodiments described herein are directed to determining adjustments based on cubic volume, similar processes may be used with respect to determining adjustments based on weight or both.

Transportation utilization may also be taken into account, in some embodiments. For example, the number of trucks that have departed and the cubic volume or weight of packages on the truck may be used in the determination of the transportation plan adjustments. For example, trucks or other types of transportation resources may leave a facility before being completely loaded or before every assigned shipment has been loaded. In some embodiments, assignments or commitments of orders, packages or shipments to transportation resources may be determined, tracked and/or used in the shipment data model to determine, for example, whether additional trucks need to be scheduled to transport additional shipments or shipments that were not loaded on an assigned truck before departure.

In some embodiments, the adjustments to the transportation plan may be sent directly to a transportation resource provider, via a reactive transportation scheduling system or may be sent via an agent that obtains or determines the adjustments from the output of the reactive transportation scheduling system (e.g., a display).

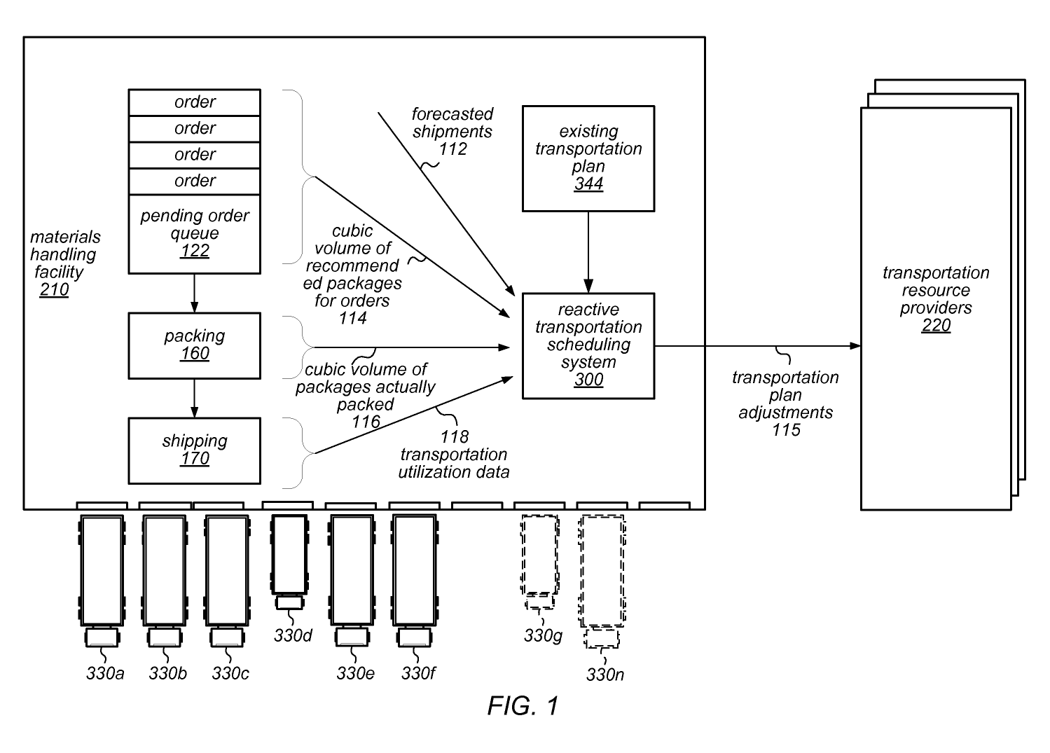

A materials handling facility may include a control system (e.g., a reactive transportation scheduling control system) that may use the cubic volume of recommended packages for received orders that have not been packed to improve the accuracy of a transportation plan scheduling or to adjust already-scheduled transportation resources. FIG. 1 is a block diagram that illustrates relationships between processes and objects of such a materials handling facility, according to some embodiments.

In FIG. 1, a pending order queue 122 of orders associated or assigned to materials handling facility 210 is illustrated. In some embodiments, the materials handling facility 210 may receive orders directly from customers such as retail or wholesale customers or from an enterprise retail system that receives orders from customers and distributes those orders to various different materials handling facilities (e.g., distribution centers) for fulfillment, for example. FIG. 1 illustrates that orders from the pending order queue 122 are packed to form shipments at packing 160 and passed on to shipping 170 where shipments may be loaded onto transportation resources (illustrated at trucks 330a-330n) for shipping to the customers that placed the orders.

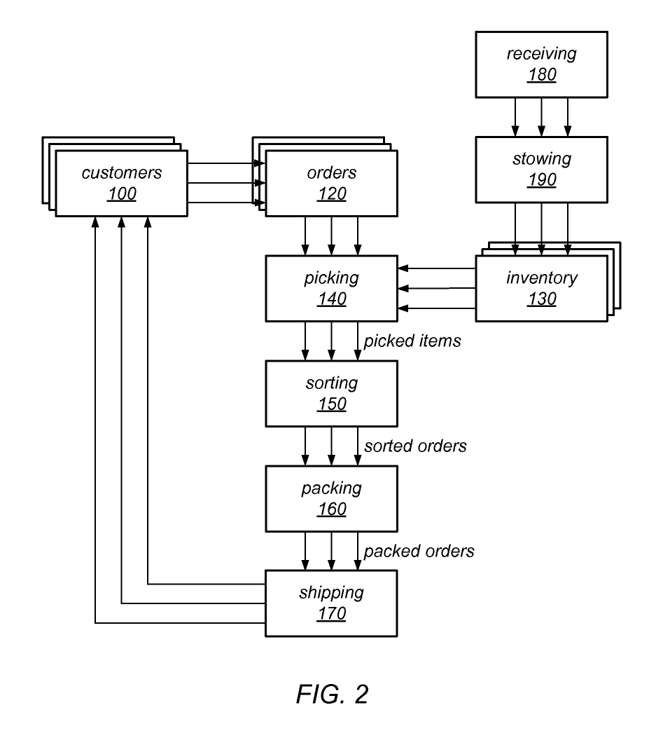

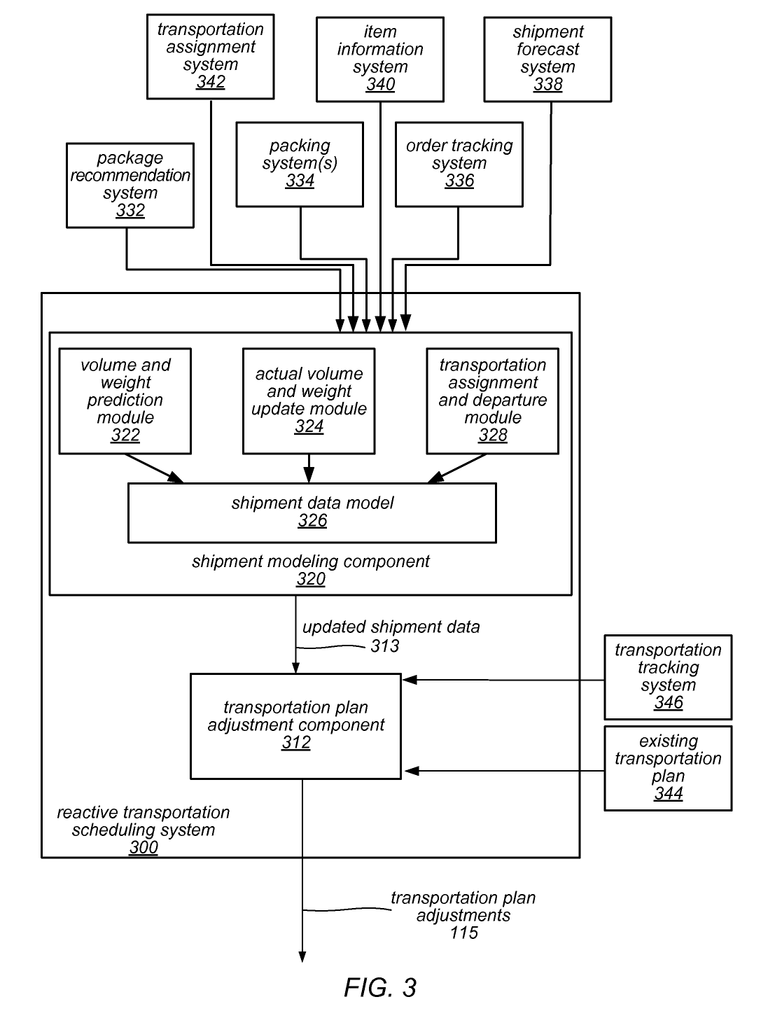

FIG. 1 illustrates a reactive transportation scheduling system 300 that may be part of a materials handling facility. The reactive transportation scheduling system 300 may receive various types of data, in some embodiments. As illustrated, the reactive transportation scheduling system 300 may receive data regarding forecasted shipment data 112, the cubic volume of recommended packages for order 114, data regarding the cubic volume of packages actually packed 116 in to shipments at packing 160 and transportation utilization data 118 regarding utilization of transportation resources, for example. The illustrated embodiment conceptually illustrates that such types of data pertain to respective processes, areas or constructs. Example sources of the data are provided in FIGS. 2 and 3, described below.

The reactive transportation scheduling system 300 may receive data, for example, forecasted shipment data 112 (e.g., forecasted shipments that the facility has not actually received orders for yet), the cubic volume of recommended packages for orders 114, the cubic volume of packages that have actually been packed 116 and transportation utilization data 118, as illustrated and output transportation plan adjustments 115, based on the received data, for example. In some embodiments, the reactive transportation scheduling system 300 may update a shipment data model with the received data and then update or adjust the transportation resource plan based on the updated shipment data model.

The reactive transportation scheduling system 300 may output transportation plan adjustments 115, for example to the transportation resource providers 220 or to a display of the materials handling facility 210. In some embodiments, the transportation plan adjustments 115 may comprise the updated transportation plan. The transportation resource providers 220 may use the transportation plan adjustments to reschedule transportation resources (e.g., trucks 330g, 330n). For example, trucks 330g and 330n may be added or removed from the scheduled transportation plan for trucks needed to ship packages from materials handling facility 210.

A distribution facility or other materials handling facility may include, in addition to a reactive transportation scheduling system 300, an inventory management system for various operations of the facility. FIG. 2 illustrates a broad view of the operations of one such facility, which, in one embodiment, may be configured to utilize a reactive transportation scheduling system as described herein. In the illustrated example, multiple customers 100 may submit orders 120 to the distributor of the items in the facility, where each order 120 specifies one or more items from inventory 130 to be shipped to the customer that submitted the order. To fulfill the customer orders 120, the one or more items specified in each order may be retrieved or “picked” from inventory 130 (which may also be referred to as stock storage) in the order fulfillment facility, as indicated by block 140. In some embodiments, agents may identify inventory locations in inventory 130 for performing operations, as described herein. Picked items may be delivered to one or more stations in the order fulfillment facility for sorting 150 into their respective orders, packing 160, and finally shipping 170 to the customers 100. Various embodiments of the illustrated facility may implement the reactive transportation scheduling system to more accurately estimate, schedule, and make adjustments to transportation plans for transportation resources used to transport shipments from the facility. A picked, packed and shipped package does not necessarily include all of the items ordered by the customer; a shipped package may include only a subset of the ordered items available to ship at one time from one facility location. In some embodiments, a shipment may include one or more packages of at least one item. In some embodiments, a shipment may be associated with a destination for the shipment.

A materials handling facility typically also includes a receiving operation 180 for receiving shipments of stock from various vendors and a stowing operation, illustrated as stowing 190, for placing the received stock into stock storage (inventory 130). In some embodiments, stowing 190 may involve stowing an item in a location within inventory 130 selected by an inventory control system (e.g., randomly, pseudo-randomly, or according to various guidelines for stowing similar or different items within the facility). In some embodiments, stowing 190 may involve scanning the item and/or the inventory location when adding items to one of the plurality of inventory areas in inventory 130.

A reactive transportation scheduling system, as described herein, may be utilized in a number of different facilities and situations, including, but not limited to material handling facilities, order fulfillment centers, rental centers, distribution centers, packaging facilities, shipping facilities, libraries, museums, warehouse storage facilities, shopping centers, grocery stores, car parking lots, etc. In general, a reactive transportation scheduling system may be used in any situation in which shipping goods from a facility via transportation resources is desirable.

The arrangement and order of operations illustrated by FIG. 2 is merely one example of many possible embodiments of the operation of a facility that implements a reactive transportation scheduling system. Other types of materials handling, manufacturing, or order fulfillment facilities and the like, may include different, fewer, or additional operations and resources, according to different embodiments

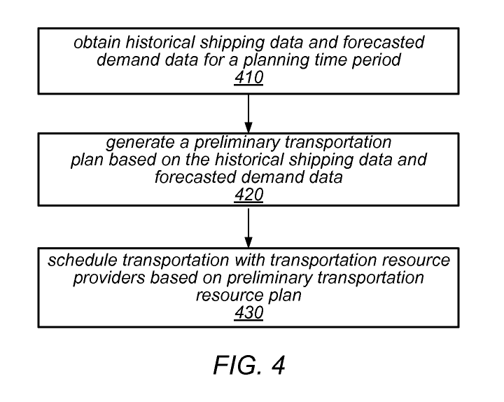

A materials handling facility may include a reactive transportation scheduling system for producing adjustments to a transportation plan. FIG. 3 illustrates a block diagram for such a reactive transportation scheduling system with a shipment modeling component 320, according to at least one embodiment. The reactive transportation scheduling system 300 may include one or more components configured to carry out various processes associated with determining transportation plan adjustments. The components may communicate among one another and with other systems, such as systems 332-342, for example. Systems 332-342 may provide data directly to shipment modeling component 320 or store the data to a data store that may be accessed by shipment modeling component 320, in various embodiments. Various components and modules illustrated in FIG. 3 may perform some or all of the processes illustrated in FIGS. 4-9.

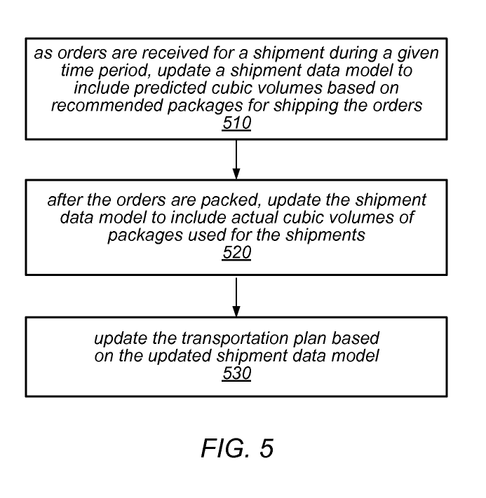

Shipment modeling component 320 may perform processes illustrated in FIG. 5, in embodiments. In the illustrated embodiment, various systems provide data to the shipment modeling component 320. In some embodiments, the systems may store data to a data store and shipment modeling component 320 may obtain the data from the data store. In other embodiments, the systems may provide the data directly to the shipment modeling component 320. For example, package recommendation system 332 may provide a package recommendation service that recommends particular packages for packing orders. For example, the package recommendation system 332 may receive a request from the shipment modeling component 320 for a recommended package for an order. In some embodiments, the request may indicate the items to be packed for the order while in other embodiments, the request may indicate the order and the package recommendation system may look up the items, for example in a data store. The package recommendation system 332 may responsively provide an indication of the recommended package (e.g., a particular size package) suitable for packing the items of the order. The indication of the particular package may be stored in a data store, with the order information or provided to the shipments modeling component, in embodiments.

Pack system(s) 334 may be configured as sources of data for one or more pack stations, in some embodiments. For example, pack system(s) 334 may act as a source of data from scanners and/or weight scales of the pack stations, although other devices of the pack station are also contemplated as sources of data. Different pack stations may be associated with different pack station system(s) 334. In embodiments, pack system(s) 334 may obtain an indication of the actual package used to pack the order and/or the weight of the shipment and provide the indication(s) to an actual volume and weight update module 324.

For example, an agent of the pack station may receive an instruction from an inventory control system to pack the order with a recommended container. Sometimes, the agent may pack the order using another container (e.g., a different size container). The agent may use another container for any number of reasons including, but not limited to running out of the recommended container at the pack station, finding that a particular item will not fit in the recommended container, or finding that the group of items for an order do not fit into the recommended container. The agent may select to use a different package than the recommended package to pack the items of the order. The agent may scan, with a scanner, a code or other indication of the different package as part of a packing process. The reactive transportation scheduling system may receive the indication of the different package from the packing system(s) 334, via scanned information from the scanner located at the pack station, for example. The packing system(s) 334 may provide the scanned information indicating the different package to a data store or to actual volume and weight update module 324 that may be configured to handle the indicator of the different package, as explained below.

Order tracking system 336 may be configured to receive orders (e.g., from an ordering system) and track the state of orders as the orders change state (e.g., from not-yet-packed to packed or from not-yet-committed to committed to a transportation resource). The order tracking system 336 may also track the physical location of orders, packages or shipments in the materials handling facility. The package tracking module may track the location of the package, in packing 160, shipping 170 or in a particular transportation resource, for example. The order tracking system 336 may provide the state of the order or location of the shipments to a data store or to the shipment modeling component 320. The order tracking system 336 may also track where the component pieces of the order are in the facility, whether the items of the package are in picking 140 or sorting 150 or in packing 160 for example.

Shipment forecast system 338 may provide forecasted shipment data 112 (e.g., forecasted shipments that the facility has not actually received orders for yet) to volume and weight predication model 322, in some embodiments. The forecasted shipment data 112 may include a quantity of forecasted orders (e.g. based on historical data) and an average shipment weight and/or cubic volume per order or shipment, in some embodiments. Such data may be used in the shipment data model 326, in embodiments.

The transportation assignment and departure module 328 may be configured to track the transportation resources and provide updates regarding the transportation resources to the shipment data model 326, in some embodiments. For example, transportation assignment system 342 may track and send data about order, package or shipment assignments, for example, how much of a transportation resource is assigned to shipments and state information about orders, packages, or shipments such as whether packages are committed to a transportation resource and to which transportation resource the packages are committed. Other systems may provide other data, in various embodiments.

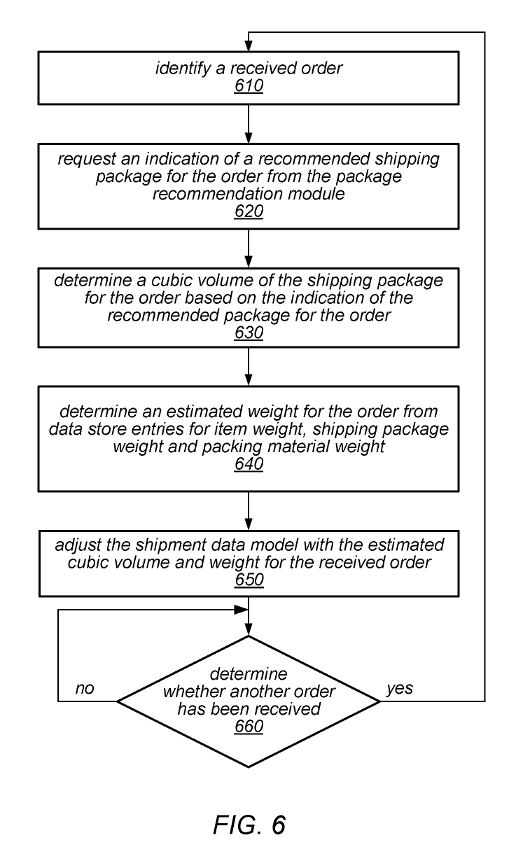

In the illustrated embodiment, shipment modeling component 320 includes volume and weight prediction module 322 that obtains or receives data from package recommendation system 332. In embodiments, the volume and weight prediction module 322 may determine the cubic volume of shipments for orders that have not been packed yet, based on order-specific box recommendations. The volume and weight prediction module 322 may perform the process illustrated in FIG. 6, in embodiments. As described above, volume and weight prediction module 322 may obtain or receive indications of recommended containers for an order from a data store or package recommendation system 332. The volume and weight prediction module 322 may obtain the cubic volume associated with the indicated recommended container (e.g., from an entry in a data store for the particular container) and update the shipment data model 326 with the cubic volume of the indicated recommended container.

The volume and weight prediction module 322 may also obtain or receive one or more weights associated with the package, for example, the weight of the items to be packed, the weight of the recommended package and the weight of the packing material. The weights may be obtained from data store entries for the items (e.g., in a product data store), the package and the packing material, for example. The weights may also be obtained from item information system 340, in some embodiments. Item information system 340 may include or have access to item information such as a product database that store information about items.

In some embodiments, volume and weight prediction module 322 may determine a predicted cubic volume for transshipments, based on the volume of a reusable container (e.g. totes of a common or known volume) that may be used for shipping the transshipments. In some embodiments, volume and weight prediction module 322 may determine a predicted cube volume for shipments to customers based on the volume of reusable containers used for shipping shipments to customers.

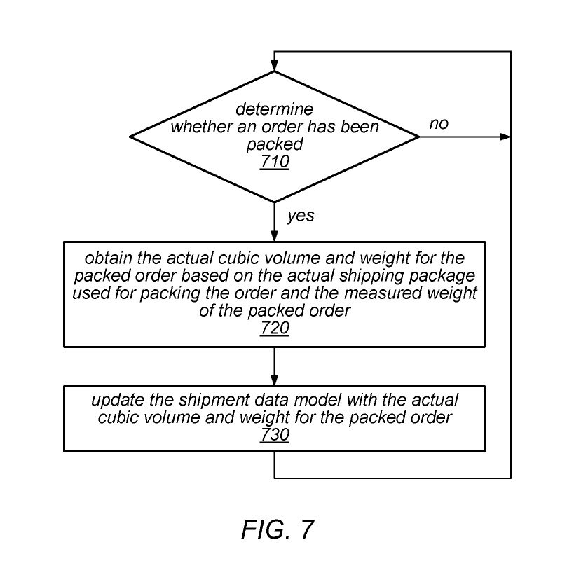

As illustrated, the shipment modeling component 320 may include an actual volume and weight update module 324. In some embodiments, the actual volume and weight update module 324 may perform the processes illustrated in FIG. 7. The actual volume and weight update module 324 may receive or obtain the actual weight and/or cubic volume of a shipment for an order that has been packed. For example, packing system(s) 334 may obtain indications of the actual cubic volume and weight for a shipment from the pack stations. The pack station may obtain, via scanner for example, a code from the package actually used to pack the order and may obtain the weight of the shipments from a scale at the station that is used to weight the packed shipments. The actual volume and weight update module 324 may interact with packing system(s) 334 to obtain the indications of the actual weight and cubic volume and update the shipment data model 326 with the indications.

Automated and/or manual systems may be used or configured to determine, obtain or provide an indication of a value for weight and/or cubic volume. In embodiments, any of various devices may be configured or techniques used to determine an indication of a value for weight (e.g., of an item, order, package or shipment). For example, scales, strain gauges, or the like may be used to determine a weight of a shipment.

In embodiments, any of various devices may be configured or techniques used to determine, obtain or provide an indication of a value for cubic volume (e.g., of an order, package or shipment). For example, ultrasonic transducers, lasers, imaging systems, cameras, etc., may be used to determine a cubic volume of a shipment. Weight or cubic volume may be determined anywhere in the facility such as at a pack station, labeling station or at another location.

In some embodiments, an actual volume and weight update module 324 may receive an indication that a different package than the recommended package was used for packing the order. The actual volume and weight update module 324 may flag the order in response to determining that a different package from the recommended package was used to pack the order. The flag may be implemented as a data entry in a data store or otherwise electronically encoded. In embodiments, the flag may indicate, for example to an administrator or agent that a different package was used such that the agent may determine a reason for use of the different package and reconfigure the system such that the recommended package is actually used to pack the order.

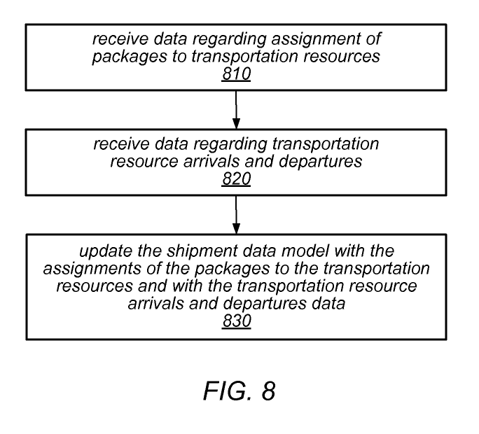

In the illustrated embodiment, shipment modeling component 320 includes a transportation assignment and departure module 328. Transportation assignment and departure module 328 may perform processes illustrated in FIG. 8, in embodiments. The transportation utilization and assignment module 328 may receive data from order tracking system 336 and transportation assignment system 342, in some embodiments. For example, the transportation assignment and departure module 328 may receive state information about packages, such as whether packages are committed to a transportation resource and to which transportation resource the packages are committed. In some embodiments, the transportation assignment and departure module 328 determines the number of committed and uncommitted packages for a time period. The number of committed packages may be determined on a resource by resource (e.g., truck by truck) basis, in some embodiments.

In embodiments, the transportation assignment and departure module 328 may track the utilization of transportation resources. For example, as trucks leave, subtracting the utilization of each truck from the committed cubic volume or weight of shipments. The transportation assignment and departure module 328 may determine transportation resource information such as the number and utilization of trucks already departed.

Together, the volume and weight prediction module 322, the actual volume and weight update module 324 and the transportation assignment and departure module 328 may determine cubic volume information, such as the cubic volume of shipments currently in the facility, by transportation resource, assignment, for example. The modules may also determine the cubic volume of shipments already packed (e.g., but not shipped), by transportation assignment, for example.

FIG. 3 illustrates that the shipment modeling component 320 may provide updated shipment data 313 to transportation plan adjustment component 312 (e.g., via data store or directly as illustrated). In some embodiments, the updated shipment data may include
the number of packages currently in the facility
the cubic volume of packages already packed
the number and capacity of transportation resources orders
the number and utilization of transportation resources already departed
the predicted cubic volume of packages for orders that have not been packed yet, based on order-specific package recommendations

Transportation plan adjustment component 312 may also receive the number of and associated capacities of transportation resources that have already been ordered, for example, via an existing transportation plan 344. The existing transportation plan may be based on historical and/or estimated demand for items and may have been used to schedule transportation resources from transportation providers.

The transportation plan adjustment component 312 may be configured to compare the shipment data model to the transportation capacity according to the transportation plan and determine transportation plan adjustments 115. The transportation plan adjustment component 312 may output transportation plan adjustments 115, as illustrated.

FIGS. 4-9 illustrate various processes associated with using estimated cubic volumes of shipments to determine adjustments to estimates of the transportation resources needed to ship the shipments. In some embodiments, transportation plan may be created to determine an amount of transportation resources to schedule for shipping the estimated cubic volume of shipments. FIG. 4 illustrates a flow diagram of a preliminary transportation plan creation process, according to one embodiment. The process illustrated in FIG. 4 may be performed by one or more components of the reactive transportation scheduling system 300, in some embodiments.

In the illustrated embodiment, the historical shipping data and forecasted demand data for a planning time period may be obtained, as indicated at block 410. For example, the historical shipping data for materials handling facility 210 and the forecasted demand data (e.g., seasonal demand data) may be obtained from a data store. The obtained data may be for a period of one day, in embodiments, although other periods of time such as, but not limited to hourly, weekly or monthly are also contemplated. At block 420, a transportation plan is generated based on the historical shipping data and the forecasted demand data. Block 430 illustrates that transportation resources may be scheduled with transportation resource providers based on the transportation plan.

In embodiments, the shipment data model 326 and the transportation plan may be updated to be more accurate as additional data is acquired during processing of the orders through the facility. FIG. 5 illustrates a flow diagram of a dynamic transportation plan update process used for a materials handling facility, in some embodiments.

The accuracy of an existing transportation plan may be increased by updating a shipment data model 326 using predicted cubic volumes (e.g., cubic volumes of recommended containers) of received orders and updating the existing transportation plan based on the updated shipment data model, in some embodiments. As illustrated at block 510, as orders are received for a shipment during a given time period, a shipment data model is updated to include predicted cubic volumes based on recommended packages for shipping the orders. For example, as described above, when actual orders are received, the package recommendation system 332 may provide an indication of a recommended package for packing the order and the volume and weight prediction module 322 may determine a cubic volume associated with the recommended package. The shipment data model 326 may be updated with the determined cubic volume of the recommended package for the order.

The accuracy of the shipment data model 326 may be increased by using the cubic volumes of the actual packages used to pack the orders into shipments, in some embodiments. Block 520 illustrates that after the orders are packed, the shipment data model may be updated to include the actual cubic volumes of packages used for the shipments. For example, actual volume and weight update module 324 may receive an indication of the package actually used to pack the order, for example, scan information from a scanner used by an agent at a pack station to scan the package. The actual volume and weight update module 324 may also receive an indication of the actual weight of the package, from a scale at the pack station that weighs packed packages, in embodiments. The actual volume and weight update module 324 may update the shipment data model with the cubic volume and/or weight of the actual package after the data is received.

As indicated at block 530, the transportation plan may be updated based on the updated shipment data model, for example, by the transportation plan adjustment component 312. In some embodiments, the shipment data model 326 may be updated continuously or as orders are received and/or as orders are packed into shipments, for example, repeating the process illustrated at blocks 510 and 520 until it is determined that the transportation plan is to be updated and then proceeding to block 530. In embodiments, the transportation plan adjustment component 312 may access the shipment data model before some orders to be shipped during the given time period have been packed such that the cubic volume of shipments to be shipped is determined based on predicted cubic volumes for some of the plurality of shipments and on actual cubic volumes for others of the plurality of shipments.

The transportation plan may be updated more or less often than the package model. For example, the transportation plan be updated based on any of, but not limited to, a need by facility management for planning transportation resources, a trigger event based transportation resource change deadlines from the transportation resource providers, or a change in one transportation provider's ability to meet scheduled transportation demand. In some, embodiments, the process may return from block 530 to block 510 where the shipment data model is updated to include predicted cubic volumes based on recommended packages. In other embodiments, the process ends at 530, waits until another order is received, or waits for another planning time period to be selected to begin the process again at 510.

As described above, a facility may be configured with a reactive transportation scheduling system 300. A reactive transportation scheduling system 300 may use cubic volumes of recommended packages for shipments to more accurately estimate transportation resources for shipping the packages, in some embodiments. FIG. 6 illustrates a flow diagram of a shipment data model adjustment process using package recommendations, implemented by a reactive transportation scheduling system of a materials handling facility, according to one embodiment.

Block 610 of FIG. 6 illustrates that a received order may be identified. In some embodiments, an order processing system (e.g., a network-based order system for an enterprise with multiple facilities) may provide a received order to the facility reactive transportation scheduling system or the reactive transportation scheduling system may obtain the order from a data store. An indication of a recommended shipping package for the order may be requested, as indicated at block 620, from the package recommendation system 332, by the volume and weight prediction module 322, for example. The package recommendation system 332 may receive an indication of the order with the request and look up the items of the order (e.g., from a data store entry for the order), analyze the items of the order and determine a recommended package to be used for packing the order. The package recommendation system 332 may store an indication of the recommended package in the data store, along with the data store entry for the order, for example, or provide the indication to the volume and weight prediction module 322 that made the request, in embodiments.

A cubic volume of the shipping package for the order may be determined based on the indication of the recommended package for the order, as illustrated at block 630. For example, the volume and weight prediction module 322 may use the indication of the recommended package to determine the cubic volume of the recommended package (e.g., from a data store entry for the package). In some embodiments, an estimated weight for the order may be determined from data store entries for item weight, package weight and packing material weight, as indicated at block 640. For example, the volume and weight prediction module 322 may obtain the weights of the items for the order from a data store (e.g., a product data store) and the package weight and packing material weight from data store entries associated with those parts of the packed package weight. The shipment data model 326 may be adjusted with the estimated cubic volume and/or weight for the received order, as indicated at block 650. For example, the estimated cubic volume and/or weight for the received order may replace the cubic volume and/or weight of forecasted demand used in the existing shipment data model.

Block 660 illustrates that a determination may be made whether another order has been received. If so, the process may return to block 610, where the received order is identified and so on. If another order has not been received, the process may wait until another order is received, in some embodiments.

The reactive transportation scheduling system 300 may use cubic volumes of the packages actually used to pack the orders to more accurately estimate transportation resources for shipping the packages, in some embodiments. For example, the actual volume and weight update module 324 may update the cubic volumes of the recommended packages of the shipment data model with cubic volumes of the packages actually used to pack the packages. FIG. 7 illustrates a flow diagram of a shipment data model update process using data from packed shipments, implemented by a reactive transportation scheduling system of a materials handling facility, according to one embodiment.

As illustrated at block 710, a determination may be made whether an order has been packed. In some embodiments, order tracking system 336 may track the position of the various components that make up an order in the facility and determine whether the component pieces of the order (e.g., the items of the order) have passed through a pack station. For instances where an order has not been packed, the process may wait until an order is packed, as indicated by the line leaving block 710 and returning to the top of block 710. In another embodiment, order tracking system 336 may receive an indication (e.g., a scanned code) from packing system(s) 334 that the items of the order have been packed as well as receive an indication of the package actually used to pack the order and the weight of the packed shipment from a scale located at the pack station, for example. The scale may be located in other portions of the facility in some embodiments, as part of an address label application process, for example. Order tracking system 336 may update the status of the order as packed, in embodiments.

The actual volume and weight update module 324 may obtain the received cubic volume and weight of the actual packed order and update the shipment data model 326 with the actual cubic volume and weight for the packed order, as indicated at block 730. For example, the cubic volume and weight from the recommended package may be replaced in the shipment data model with the cubic volume and weight of the actual package. The process may then return to block 710 where the process determines whether an order has been packed and so on.

Adjustments to a transportation plan may depend upon transportation utilization and package assignments, in some embodiments. For example, trucks departing the facility only partially full may cause the need for additional trucks later on. FIG. 8 illustrates a flow diagram of a transportation utilization update process implemented by a reactive transportation scheduling system of a materials handling facility, according to one embodiment.

A reactive transportation scheduling system 300 may include a transportation utilization and assignment module 324, in some embodiments. Data regarding assignments of packages to transportation resources may be received, as indicated at block 810, by transportation assignment and departure module 328, for example. Assignment or commitment of a package to particular transportation resource may indicate an intention that the package be shipped via the transportation resource. In embodiments, the data regarding assignments of the shipments to transportation resources are during a given time period, and the transportation plan adjustment component 312 may update the existing transportation resource plan based on a quantity of shipments that have been assigned to transportation resources and a quantity of shipments that have not yet been assigned to a transportation resource during the given time period.

In some embodiments, transportation resource scheduling may change (e.g., trucks may arrive late or not at all). Packages may not be assigned to particular transportation resources until the last possible moment (e.g., to avoid the need to re-assign the packages). In other embodiments, order, packages, or shipments may be assigned to a particular transportation resource closer to when the order is received or sometime thereafter.

Data associated with transportation resource arrivals and departures for some recent time period (e.g., a day or a number weeks or an average of the last few days or weeks) and/or seasonal trends may also be received, as illustrated at block 820, for example, transportation tracking system 346 may provide such transportation data to transportation plan adjustment component 312 which may update the transportation plan in accordance with the received data. The data may include transportation utilization data, the cubic volume or weight of packages that were on the transportation resources that departed, for example. In some embodiments, the utilization may be tracked on a package by package basis, on a pallet by pallet basis or otherwise, for example as a percentage of the available cubic volume or weight the transportation resource is capable of or was assigned to hold. The utilization of a transportation resource may be tracked as the resource is loaded with packages and values associated with the total load cubic volume and/or weight may be stored for analysis after the resource has been loaded with packages. In some embodiments, the transportation resource data, such as the departure and arrival data may be modeled separately from and/or provided to the transportation plan adjustment component separately from the shipment data model 326.

As illustrated at block 830, the shipment data model may be updated with the assignments of the packages to the transportation resources and with the transportation resource arrivals and departures data, by transportation assignment and departure module 328, for example. In embodiments, the cubic volume of packages on trucks that leave the facility (e.g., the truck utilization) is subtracted from the committed but not shipped package cubic volume of the facility, for example.

In some embodiments, the processes describes in blocks 810, 820 and 830 may be performed in an order other than the order illustrated, the process illustrated in block 820 may be performed before the process illustrated in 810, for example. In some embodiments, the processes illustrated in blocks 810, 820 and 830 may be performed repeatedly, continuously or iteratively, the process of 810 being performed again, after the process of 830, and so on. In some embodiments, the processes 810-830 may be performed according to a schedule.

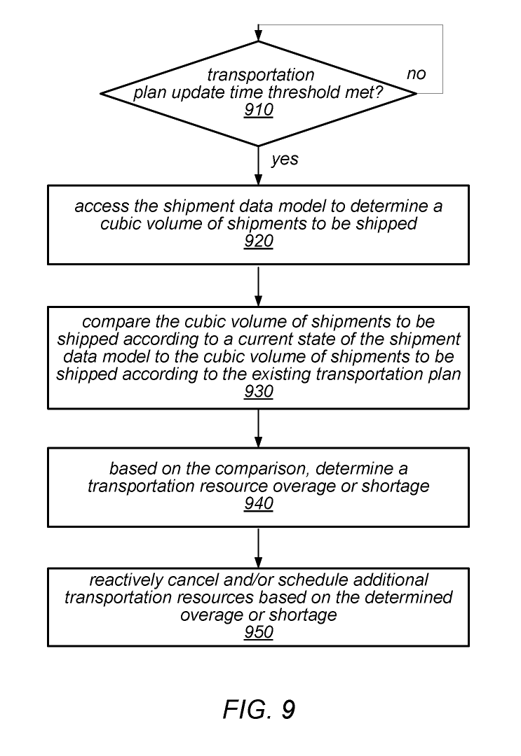

In some embodiments, the processes described in FIGS. 4-8 may be performed independently of one another, for example, the shipment data model creation and transportation generation process of FIG. 4 may be performed before of the shipment data model update process of FIG. 7. In some embodiments, portions of the processes illustrated in FIGS. 4-8 may be mixed and matched to form a custom transportation plan adjustment process. FIG. 9 illustrates a flow diagram of a particular transportation plan adjustment determination process implemented by a reactive transportation scheduling system of a materials handling facility, according to one embodiment.

At 910, a determination is made whether a transportation plan update time threshold had been met. In some embodiments the determination may be made based on a schedule, for example a schedule dictated by an incentive plan of a transportation resource provider to accurately schedule transportation resources with a time period. Entities may schedule more transportation resources than necessary in an effort to avoid missed shipments or scheduling delays, for example. However, the entity may turn back the unused transportation resources only after the resources have arrived at the facility (e.g., when it is determined that some of the resources were not actually needed), thus incurring costs (travel and labor expense) to the transportation resource provider. Transportation resource providers may provide incentives to an entity to schedule transportation needs more accurately. For example, a transportation resource provider may charge a fee for any resource that is canceled less than some time period before the resource is scheduled to arrive at the facility. The time period may be used by the entity in determining when to update the transportation model so as to provide adjustments to the transportation plan and avoid fees for scheduled but unused transportation resources. Different transportation resource providers may be associated with different transportation model update times, in embodiments. In some embodiments, the transportation plan may be updated for other reasons, such as based on the planning needs of management or based on a known change to the package model, such as the cancellation of a large number of orders. If the time threshold for the transportation plan update has not been met, the process may return to block 910, and wait until the time threshold is met.

For instances where the transportation plan update time threshold has been met, the shipment data model may be accessed to determine a cubic volume of shipments to be shipped, as indicated at block 920. As illustrated at block 930 the cubic volume of shipments to be shipped according to a current state of the shipment data model may be compared to the cubic volume of shipments to be shipped according to the existing transportation plan 344 and based on the comparison, a transportation resource overage or shortage may be determined, as indicated at block 940. For example, if the shipment data model indicates a greater cubic volume than was planned for, a shortage may be determined and if the shipment data model indicates less cubic volume than was planned for, an overage may be determined. In some embodiments, the state of the shipment data model may be that the shipment data model includes predicted cubic volumes for some of the shipments and actual cubic volumes for others of the shipments. In some embodiments, the state of the shipment model may be that the shipment data model includes only predicted cubic volumes or only actual cubic volumes.

As indicated at block 950, transportation resources may be reactively cancelled and/or additional resources may be scheduled based on the determined overage or shortage. For example, the adjustments may be sent to the transportation resource providers electronically, via the system or via an agent of the facility, for example. In other embodiments, a report of the determined transportation overage or shortage may be generated for display.

In embodiments, the adjustments to the transportation plan may be output to another component of the reactive transportation scheduling system or to a screen for an agent of the facility to read and provide to one or more transportation resource providers or the adjustments may be sent directly to a computer systems of the transportation resource providers, via the facility control system. In some embodiments, the transportation plan itself may be displayed to an agent of the facility or transmitted electronically to the transportation resource providers.

In embodiments, a hysteresis may be built into the reactive transportation scheduling system 300, to reduce the amount of vacillations associated with transportation resource scheduling. For example, transportation resource providers may prefer to minimize the number of adjustments to a transportation plan as well as receive the adjustments as early as possible. As such the reactive transportation scheduling system may be configured to minimize such wavering, with a delayed response, for example.

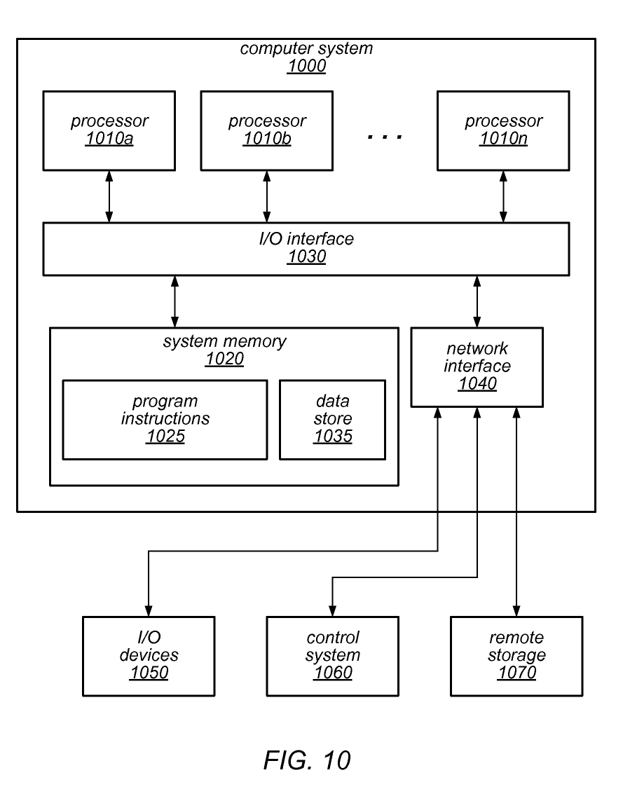

Any of various computer systems may be configured to implement a system for transportation resource estimation based on recommended shipping packages within a materials handling facility. For example, FIG. 10 is a block diagram illustrating one embodiment of a computer system suitable for implementing the system and methods described herein. In various embodiments, a control system (e.g., reactive transportation scheduling system 300 of FIG. 3), a materials handling facility (e.g., materials handling facility 210), a pack station, or a communication device (e.g., scanner, a scale) may each include a general-purpose computer system such as computer system 1000 illustrated in FIG. 10.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030. In some embodiments, computer system 1000 may be illustrative of reactive transportation scheduling system 300, while in other embodiments reactive transportation scheduling system 300 may include more, fewer, or different elements than computer system 1000. In some embodiments, computer system 1000 may be illustrative of control system, (e.g., 300), or a communication device (e.g., scanner) while in other embodiments a reactive transportation scheduling system or communication device may include more, fewer, or different elements than computer system 1000.

In various embodiments, computer system 1000 may be a uniprocessor system including one processor 1010, or a multiprocessor system including several processors 1010 (e.g., two, four, eight, or another suitable number). Processors 1010 may be any suitable processors capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

System memory 1020 may be configured to store instructions and data accessible by processor 1010. In various embodiments, system memory 1020 may be implemented using any suitable memory technology, such as static random access memory (SRAM), synchronous dynamic RAM (SDRAM), non-volatile/Flash-type memory, or any other type of memory. In the illustrated embodiment, program instructions and data implementing desired functions, such as those methods and techniques described above for a reactive transportation scheduling system, a fulfillment center control system, or a communication device, are shown stored within system memory 1020 as program instructions 1025. In some embodiments, system memory 1020 may include data 1027 (e.g., a product database) which may be configured as described herein.

In one embodiment, I/O interface 1030 may be configured to coordinate I/O traffic between processor 1010, system memory 1020 and any peripheral devices in the system, including through network interface 1040 or other peripheral interfaces. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. Also, in some embodiments, some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, for example. In particular, network interface 1040 may be configured to allow communication between computer system 1000 and/or various I/O devices 1050. I/O devices 1050 may include scanning devices, display devices and/or other communication devices, as described herein. Network interface 1040 may commonly support one or more wireless networking protocols (e.g., Wi-Fi/IEEE 802.11,or another wireless networking standard). However, in various embodiments, network interface 1040 may support communication via any suitable wired or wireless general data networks, such as other types of Ethernet networks, for example. Additionally, network interface 1040 may support communication via telecommunications/telephony networks such as analog voice networks or digital fiber communications networks, via storage area networks such as Fibre Channel SANs, or via any other suitable type of network and/or protocol.

In some embodiments, system memory 1020 may be one embodiment of a computer-accessible medium configured to store program instructions and data as described above. However, in other embodiments, program instructions and/or data may be received, sent or stored upon different types of computer-accessible media. Generally speaking, a computer-accessible medium may include computer-readable storage media or memory media such as magnetic or optical media, e.g., disk or DVD/CD-ROM coupled to computer system 1000 via I/O interface 1030. A computer-readable storage medium may also include any volatile or non-volatile media such as RAM (e.g. SDRAM, DDR SDRAM, RDRAM, SRAM, etc.), ROM, etc, that may be included in some embodiments of computer system 1000 as system memory 1020 or another type of memory. Further, a computer-accessible medium may include transmission media or signals such as electrical, electromagnetic, or digital signals, conveyed via a communication medium such as a network and/or a wireless link, such as may be implemented via network interface 1040.

In some embodiments, I/O devices 1050 may be relatively simple or “thin” client devices. For example, I/O devices 1050 may be configured as dumb terminals with display, data entry and communications capabilities, but otherwise little computational functionality. However, in some embodiments, I/O devices 1050 may be computer systems configured similarly to computer system 1000, including one or more processors 1010 and various other devices (though in some embodiments, a computer system 1000 implementing an I/O device 1050 may have somewhat different devices, or different classes of devices).

In various embodiments, I/O devices 1050 (e.g., scanners or display devices and other communication devices) may include, but are not limited to, one or more of: handheld devices, devices worn by or attached to the agents, and devices integrated into or mounted on any mobile or fixed equipment of the materials handling facility such as pushcarts, bins, totes, racks, shelves, tables, ceilings, walls, and work benches, according to various embodiments. I/O devices 1050 may further include, but are not limited to, one or more of: personal computer systems, desktop computers, rack-mounted computers, laptop or notebook computers, workstations, network computers, “dumb” terminals (i.e., computer terminals with little or no integrated processing ability), Personal Digital Assistants (PDAs), mobile phones, or other handheld devices, proprietary devices, printers, or any other devices suitable to communicate with reactive transportation scheduling system 300. In general, an I/O device 1050 (e.g., cursor control device 1060, keyboard 1070 or display(s) 1080) may be any device that can communicate with reactive transportation scheduling system 300 and convey instructions to agents within the facility. In one embodiment, at least some of the I/O devices 1050 may be configured to scan or otherwise read or receive codes or identifiers of various components in the materials handling facility and to communicate the entered codes to reactive transportation scheduling system 300 for use in directing agents in the various operations of the control center (e.g., bar code scanners, RFID readers, cameras, or any other sensing devices). Such components may include, but are not limited to, one or more of items, orders, packing stations, bins, and compartments of bins.

The various methods as illustrated in the figures and described herein represent exemplary embodiments of methods. The methods may be implemented manually, in software, in hardware, or in a combination thereof. The order of any method may be changed, and various elements may be added, reordered, combined, omitted, modified, etc. For example, in one embodiment, the methods may be implemented by a computer system that includes a processor executing program instructions stored on a computer-readable storage medium coupled to the processor. The program instructions may be configured to implement the functionality described herein (e.g., the functionality of the control system, product database, and/or other communication devices).

Various modifications and changes may be made as would be obvious to a person skilled in the art having the benefit of this disclosure. It is intended to embrace all such modifications and changes and, accordingly, the above description to be regarded in an illustrative rather than a restrictive sense.

1. A system, comprising:
one or more computing devices comprising processor hardware and configured to implement a reactive transportation scheduling system configured to:
transmit instructions scheduling transportation to one or more transportation resource providers in accordance with an existing transportation resource plan;
determine, subsequent to receipt of orders to be shipped during a given time period, recommended packages for a plurality of shipments for the received orders, wherein the recommended packages are not yet packed;
determine a predicted cubic volume for each of the plurality of shipments based on the respective recommended packages for the received orders;
update a shipment data model with the predicted cubic volumes for the plurality of shipments for the received orders;
a packing system configured to direct packaging of the received orders into recommended packages; and
a scanning device configured to obtain an indication of actual packages used to pack the plurality of shipments;
the reactive transportation scheduling system further configured to:
subsequent to the orders being packed for the plurality of shipments, update the shipment data model with cubic volumes of actual packages used for packing the plurality of shipments;
access the shipment data model during the given time period to determine a cubic volume of shipments to be shipped;
determine a quantity of transportation resources needed to ship the cubic volume of shipments to be shipped;
update the existing transportation resource plan based on a difference between the determined quantity of transportation resources and a quantity of transportation resources specified in the existing transportation resource plan; and
transmit one or more changes to the existing transportation resource plan to the one or more transportation resource providers.

2. The system of claim 1, wherein the reactive transportation scheduling system is further configured to access the shipment data model before one or more orders to be shipped during the given time period have been packed such that the cubic volume of shipments to be shipped is determined based on predicted cubic volumes for one or more of the plurality of shipments and on actual cubic volumes for others of the plurality of shipments.

3. The system of claim 1, wherein:
the reactive transportation scheduling system is further configured to:
update the shipment data model with data regarding assignments of the plurality of shipments to transportation resources during the given time period, and
update the existing transportation resource plan based on a quantity of shipments that have been assigned to transportation resources and a quantity of shipments that have not yet been assigned to a transportation resource during the given time period.

4. The system of claim 1, wherein:
the reactive transportation scheduling system is further configured to:
access a data store to determine weight information of items that have not yet been packed for shipments to be shipped during the given time period;
determine predicted weights for the shipments based on the determined weight information;
update the shipment data model with the predicted weights for the shipments;
subsequent to the orders being packed for the shipments, update the shipment data model with actual weights of the shipments; and
determine the quantity of transportation resources needed to ship the shipments based on both the cubic volumes and weights from the shipment data model.

5. The system of claim 1, wherein the reactive transportation scheduling system is further configured to update the existing transportation resource plan and transmit the one or more changes in response to a trigger event based on one or more transportation resource change deadlines from one or more of the transportation resource providers.

6. A method, comprising:
performing, by one or more computing devices:
updating, as orders are received for shipment during a given time period, a shipment data model to include predicted cubic volumes based on recommended packages for shipping shipments of the orders that are not yet packed;
direct, at a pack station, packaging of the received orders into the recommended packages;
receive, from a scanning device, indications of actual packages used to pack the orders into shipments;
subsequent to the orders that are not yet packed being packed, updating the predicted cubic volumes of the shipment data model with actual cubic volumes of packages used for packing the orders into shipments, wherein the actual cubic volumes are based at least in part on the indications of actual packages;
determining, based at least in part on the updated shipment model that includes the actual cubic volumes, changes to an existing transportation resource plan for shipping the shipments during the given time period; and
transmitting, based at least in part on the changes to the existing transportation resource plan, one or more changes to one or more transportation resource providers.

7. The method of claim 6, wherein said updating the shipment data model to include predicted cubic volumes comprises:
accessing a package recommendation system to obtain indications of the recommended packages for shipping the orders;
determining cubic volumes of the recommended packages; and
updating the shipment data model based on the determined cubic volumes of the recommended packages.

8. The method of claim 6, wherein said updating the shipment data model to include predicted cubic volumes and said updating the shipment data model to include actual cubic volumes are performed in a continuous manner as orders are received and packed, respectively.

9. The method of claim 6, further comprising:
determining predicted weights for the shipments based on item data for the orders;
updating the shipment data model with the predicted weights for the shipments; and
subsequent to the orders being packed for the shipments, updating the shipment data model with actual weights of the shipments.

10. The method of claim 6, further comprising:
comparing the shipment data model to a transportation capacity according to the existing transportation plan; and
determining a transportation resource overage or shortage based on the comparison.

11. The method of claim 10, further comprising generating a report of the determined transportation overage or shortage for display.

12. The method of claim 10, further comprising reactively cancelling transportation resources or scheduling additional transportation resources based on the determined transportation overage or shortage, respectively.

13. A non-transitory computer-readable medium storing program instructions that when executed by a computer system implement a reactive transportation scheduling system comprising:
a shipment modeling component configured to:
update a shipment data model with predicted cubic volumes based on recommended packages for shipping received orders during a given time period, wherein the recommended packages are not yet packed;
receive, based at least in part on an indication, from a packing station scanning device, of actual packages used to pack the orders into shipments, actual cubic volumes of packages used to pack the orders for shipment; and
update, subsequent to the orders being packed, the shipment data model with actual cubic volumes of packages used to pack the orders for shipment; and
a transportation plan adjustment component configured to:
access the shipment data model during the given time period to determine a cubic volume of shipments to be shipped;
determine, based on the cubic volume of shipments to be shipped according to a current state of the shipment data model, changes to an existing transportation resource plan for scheduling transportation resources to ship the orders during the given time period;
wherein the reactive transportation scheduling system is configured to transmit, based at least in part on the changes to the existing transportation resource plan, one or more transportation plan adjustments to one or more transportation resource providers.

14. The non-transitory computer-readable medium of claim 13, wherein the current state of the shipment model includes only predicted cubic volumes for at least some of the shipments and actual cubic volumes for others of the shipments.

15. The non-transitory computer-readable medium of claim 13, wherein to update the shipment data model to include actual cubic volumes, the shipment modeling component is further configured to:
determine a package actually used to pack an order;
determine a cubic volume of the package actually used to pack the order; and
update the shipment data model based on the determined cubic volume of the package actually used to pack the order.

16. The non-transitory computer-readable medium of claim 13, wherein the program instructions are further configured to implement:
a transportation assignment and departure module configured to receive assignment data assigning shipments to a transportation resource; and
wherein the shipment modeling component is further configured to update the shipment data model to indicate transportation resource assignments for shipments.

17. The non-transitory computer-readable medium of claim 16, wherein the transportation assignment and departure module is further configured to:
receive data regarding transportation resource departures that have departed from a facility performing the shipping; and
update the shipment data model to indicate transportation resources that have departed, wherein the shipment data model reduces the cubic volume of shipments to be shipped in accordance with the cubic volumes of the shipments of the departed transportation resources.

18. The non-transitory computer-readable medium of claim 13, wherein to determine changes to the existing transportation resource plan, the transportation plan adjustment component is further configured to update the existing transportation plan based on a difference between a quantity of transportation resources needed to ship remaining shipments according to the shipment data model and a scheduled quantity of transportation resources specified in the existing transportation resource plan.

19. The non-transitory computer-readable medium of claim 18, wherein the reactive transportation scheduling system is further configured to output one or more adjustments to the existing transportation plan based on the difference between the needed quantity of transportation resources and the scheduled quantity of transportation resources specified in the existing transportation resource plan.

20. The non-transitory computer-readable medium of claim 18, wherein the reactive transportation scheduling system is configured to reactively cancel transportation resources or schedule additional transportation resources based on the difference between the needed quantity of transportation resources and the scheduled quantity of transportation resources specified in the existing transportation plan.
